(19) United States
(12) Patent Application Publication
(10) Pub. No.: US 2006/0248185 A1
(43) Pub. Date: Nov. 2, 2006

(54) System and method for utilizing a presence service to advertise activity availability

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/118,882

(22) Filed: Apr. 29, 2005

(51) Int. Cl. G06F 15/173

(52) U.S. Cl. 709/224

(57) ABSTRACT

A system and method for advertising over a network an invitation to engage in at least one activity is described. In one embodiment, a presence service on the network receives from an inviting presence client activity information related to at least one activity the inviting presence client is interested in participating. The presence service then updates a tuple associated with the inviting presence client to include the information related to the activity, and sends the invitation to engage in the activity to at least one other presence client on the network.

### CROSS-REFERENCE TO RELATED APPLICATIONS

The present application is related to co-pending U.S. patent application Ser. No. 11/______ , entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and assigned to the assignee of the present application. The present application is also related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Each of the above-cited related applications is incorporated here by reference in its entirety.

### FIELD OF THE INVENTION

The present invention relates to a presence service and more particularly to a method and system for utilizing a presence service to advertise availability to engage in an activity.

### BACKGROUND OF THE INVENTION

Instant messaging (IM) services provide a well known mechanism for allowing computer users to communicate online, for example, by sending a message or chatting with another user. Such services are typically provided by AOL, MSN, Yahoo, and other similar service providers. Certain data associated with users of such IM services is known as presence information. Presence information typically consists of one or more presence tuples, which represent the status, an optional activity address, and other information relating to each user. The status of the user can simply be open or closed, when the computer system will or will not accept instant messages for the user. Other examples of the status of the user can include “online”, “away from my desk”, “stepped out”, or “on the phone”. Based on the status of a user, other users may decide whether to initiate activities with the user.

Presence tuples may also include contact information. Contact information includes contact addresses at which a user can be reached. The contact addresses can include MMS, email, postal addresses, ftp addresses, phone number(s), facsimile numbers and other mechanisms available for reaching a particular user, as well as contact priorities. Contact priorities indicate the best or preferred (highest priority) mechanism for reaching a user. For example, in certain instances, a user's email account may have a higher contact priority than his cell phone, and vice versa.

Systems which store and provide presence information are known as presence services. IM is one type of application which may be built which makes use of a presence service. More information on IM, presence services, and presence information can be found at the jabber.org/jeps site. For example documents jep-0132.html, and jep-0119.html are of interest. In addition, the ieff.org site contains internet related documents related to presence information and IM. Such documents include draft-ietf-impp-cpim-pidf-08.txt in the internet-drafts section of the ieff.org site, as well as rfc2778.txt and rfc2779.txt in the RFC section of the ieff.org site.

As part of IM services and other services that utilize a presence service, a conventional friends list is often supported. Such a conventional friends list provides a user with information from the presence tuples of other users (e.g. other users of the IM service) who are associated with the user. More specifically, status information for the “friends” is provided in the friends list. For example, while a user is online, the conventional friends list is typically displayed in a window on the user's display. Using the friend's list, a user can determine whether to send a message to an entity on the friends list. For example, if a particular friend's status is “busy” or “away from my desk,” the user may opt not to attempt to start a chat session with that particular friend.

A user is represented to the presence service through a presence client. The presence client sends status information reflecting the user's status to the presence service via a presentity. A presentity interacts with a presence service to provide presence information to the service concerning the presence client it represents. The presentity may be a component of the presence client or an external service.

The user provides presence information concerning him/herself by interacting with the presence client through a presence user agent (PUA). A PUA may be a component of the client or an external service. For example, in a typical IM client, the PUA is simply the interface with which the user interacts to change his/her status.

The presence client uses a watcher to retrieve presence information, such as friends list data, from a presence service. A watcher interacts with the presence service to receive presence information concerning other users, for example. Watchers come in several varieties. Two common varieties are fetchers which request presence information as needed and subscribers which subscribe to events related to presence tuple additions, deletions, updates, and other alterations.

The presence client displays presence data, e.g., the user's friends list, through a watcher user agent (WUA). As with presentities and PUAs, watchers and WUAs may be part of the presence client or may be external services used by or acting on behalf of the presence client.

Although conventional presence services and conventional friends lists are useful, one of ordinary skill in the art will readily recognize that there are significant limitations associated with the current methods of utilizing presence information. In particular, presence tuples typically include information relating to a user's current status only. No information relating to the user's availability to participate in future or concurrent activities is provided. This can be problematic if the user is willing and available to participate in a concurrent or future activity.

For instance, a user is engaged in a business conference call and wants to have dinner with friends in an hour, but cannot contact his friends because of the conference call. While the presence information of the user indicates that he is “on the phone,” it does not indicate that the user would like to have dinner with his friends in an hour. Thus, the user's friends might make alternative plans for the evening.

Accordingly, what is needed is a method and system for extending presence services to enable a presence client to advertise its availability to engage in present or future activities. The method and system should allow the presence client to determine to which friends the advertisement will be directed. The present invention addresses such a need.

### SUMMARY OF THE INVENTION

The present invention provides a method and system for advertising over a network an invitation to engage in at least one activity. In one embodiment, a presence service on the network receives from an inviting presence client activity information related to at least one activity the inviting presence client is interested in participating. The presence service then updates a tuple associated with the inviting presence client to include the information related to the activity, and sends the invitation to engage in the activity to at least one other presence client on the network.

### DESCRIPTION OF SEVERAL VIEWS OF THE DRAWINGS

FIG. 1 is a block diagram of a system according to one embodiment of the present invention.

FIG. 2 is a block diagram of an exemplary device according to one embodiment of the present invention.

FIG. 3 is an illustration of an exemplary user interface according to one embodiment of the present invention.

FIG. 4 is an exemplary presence tuple according to one embodiment of the present invention.

FIG. 5 is a high-level flowchart of a method for advertising an invitation to engage in an activity according to one embodiment of the present invention.

FIG. 6 is a flowchart illustrating a process for responding to an invitation to engage in an activity according to a preferred embodiment of the present invention.

FIG. 7 is a flowchart illustrating a method of automatically scheduling an activity according to one embodiment of the present invention.

### DETAILED DESCRIPTION OF THE INVENTION

The present invention relates to a presence service and more particularly to a method and system for utilizing a presence service to advertise a presence client's availability to engage in an activity. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

This document uses terms described in RFC2778 and RFC2779 when discussing the architecture and protocols associated with presence services. While the various presence service and presence protocol embodiments used today have differences, all of these embodiments use presence architectures and protocols that are consistent with the architecture and protocols described in RFC2778 and RFC2779 in terms of features and function. Accordingly, the terms used here should not be limited to any one of the presence services and/or protocol embodiments in use today.

For example, today's presence protocols each support a common set of commands from a functional standpoint (See RFC2779). These function commands include:
Publish: Allowing a presence entity (through a PUA/presentity) to update/provide its own presence tuple information (e.g. its status or contact information);
Notify: Allowing a presence service to provide information from a presence tuple to a WUA/watcher. Notifications may be point-to-point or broadcast; and
Subscribe, Subscribed, Unsubscribe, Unsubscribed: Allowing a WUA/watcher to subscribe and unsubscribe to notifications related to specific tuple data.

Several optional functionally equivalent commands also exist. These equivalent commands include:

Probe: Allowing a presence service to get information associated with a presence entity. This is equivalent to a Notify except that the presence service requests the data rather than having the presence client send the data unsolicited; and

Directed Publish/Notification: Allowing a client to issue a publish which results in a Notification to a specific presence client.

There are also a functional equivalent set of commands for managing a “friends list” which will be referred to as a “roster” to match the RFC documents related to presence services. This set of commands includes:
Request Roster: Allowing a client to request a specific or default roster;
Add: Allowing a client to add an item for a presence entity to a roster;
Update: Allowing a client to update a roster item; and
Delete: Allowing a client to delete an item from a roster.

Related to rosters are privacy lists. Privacy lists can be described as rosters having a specific purpose of identifying presence clients that are to be blocked from interacting with the owner of the privacy list.

According to one embodiment of the present invention, a method and system is provided that allows a user to utilize a presence service to advertise to selected invitees the user's availability to engage in an activity presently or in the future. The method and system allows an invitee to select which, if any, of the activities offered the invitee is interested in, and if necessary, facilitates the scheduling of a mutually convenient time and place for the activity.

In one embodiment, the method and system of the present invention is based on an instant messaging service framework. Instant messaging (IM) is a well known mechanism for allowing real time communication between a first device and a second device over a network. Unlike other conventional methods of communication between client devices, e.g., electronic mail, IM provides a direct communication pipeline between the first and second devices so that a message is received and displayed in real time, i.e., as it is being entered in by a first user of the first client device. In addition to exchanging real time text messages, IM also permits real time sharing of other types of data, such as for example, static files and active content on a user's device. According to one embodiment of the present invention, a presence service is used to facilitate events and activities between presence clients.

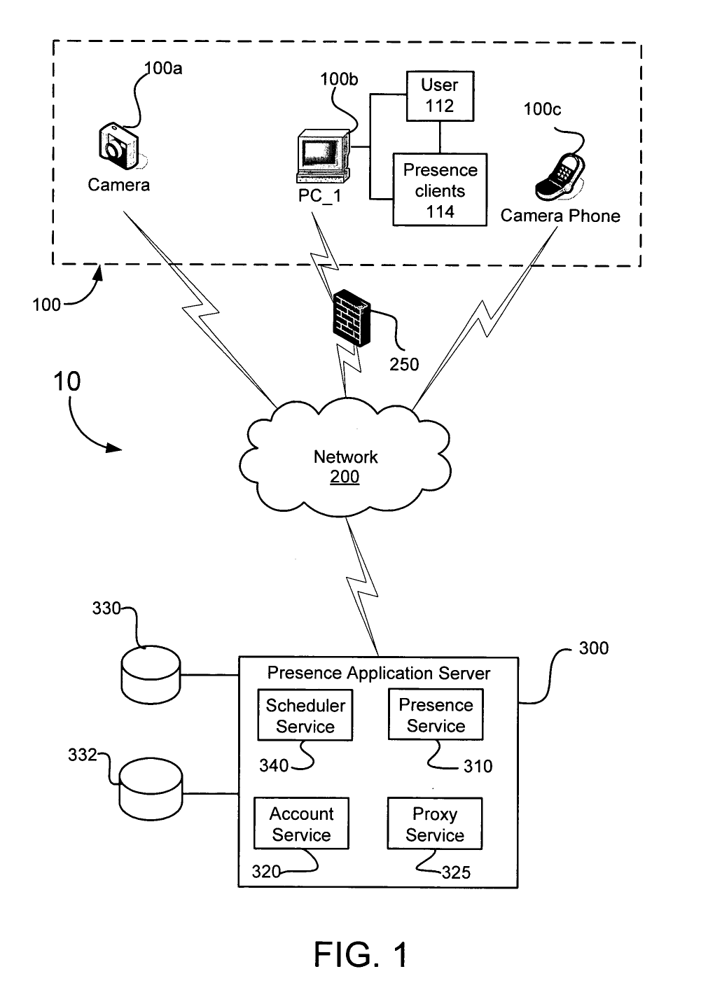

FIG. 1 is a schematic block diagram of a system according to one embodiment of the present invention. Client devices 100a, 100b, 100c, collectively referred to as devices 100, communicate with one another through a network 200, such as the Internet. According to one embodiment of the present invention, a user 112 of a device, e.g., the personal computer 100b, utilizes any of a plurality of presence clients 114 in the device 100b to communicate with other presence clients 114 in the other client devices 100a, 100c. Note that although the user 112 is typically a human entity, the user 112 can also include services and applications (not shown) residing in the device 100 that use the presence clients 114 to indicate their respective presence information to other interested entities.

The system 10 includes a presence application server 300 that is accessible by the devices 100 through the network 200. The presence application server 300 includes the presence service 310, an account service 320 and a proxy service 325. In a preferred embodiment, the presence service 310 manages, e.g., receives, stores, updates and provides, global presence information for the presence service clients 114, user(s) 112, devices 100, and other components.

As stated above, presence information typically includes the presence client's status and other information relating to each client. For example, the status of a client, e.g., a user, can simply be “open” or “closed,” indicating whether the user is available. Other examples of the client's status can include “online”, “away from my desk”, “stepped out”, or “on the phone.” The presence information for a presence client 114 can also include contact information, which includes contact addresses at which the client can be reached. The contact addresses can include MMS, email, postal addresses, ftp addresses, phone number(s), facsimile numbers and other mechanisms available for reaching a particular client, as well as contact priorities.

The presence information is preferably stored in a presence data storage structure 330, such as a database, that is in communication with the presence application server 300. The presence information can be in the form of a tuple for each presence service client. According to an exemplary embodiment, the tuple associated with each presence service client can be a presence tuple. Typically, the presence tuple is a structured format that fully describes and defines the presence information associated with the presence client 114. For example, the presence tuple can be part of a structured document using XML. Although the presence data storage structure 330 is depicted as having a particular location remote from the devices 100, nothing prevents the storage structure 330 from being stored in another location. For example, all or a portion of the presence information may be stored in a memory structure (not shown) on the devices 100 or on another memory structure (not shown).

The account service 320 in the presence application server 300 manages client accounts and information related to presence clients other than presence information. For example, such client related information can include a user-defined list of preferred contacts that can include friends, relatives, co-workers, etc., commonly referred to as a “friends list,” and authentication information and authorization data for each contact on the list.

The client related information is preferably stored in a friends data storage structure 332, such as a database, that is in communication with the presence application server 300. Alternatively, the storage structure 332 can be located elsewhere. For example, all or a portion of the client related information may be stored in a memory structure (not shown) on the devices 100 or on another memory structure (not shown).

The friends data storage structure 332 is shown separately from the presence information data storage structure 330 for the sake of clarity. Those with ordinary skilled in the art would readily appreciate that the presence information and client related information can be stored separately or in the same data structure.

The proxy service 325 associated with the presence application server 300 serves as a proxy among the devices 100 in the network 200. The proxy service 325 permits the devices 100 to communicate with one another through a firewall 250 in a known manner. The proxy service 325, while shown in the presence application server 300 can reside in a separate server (not shown) or with the presence service 310.

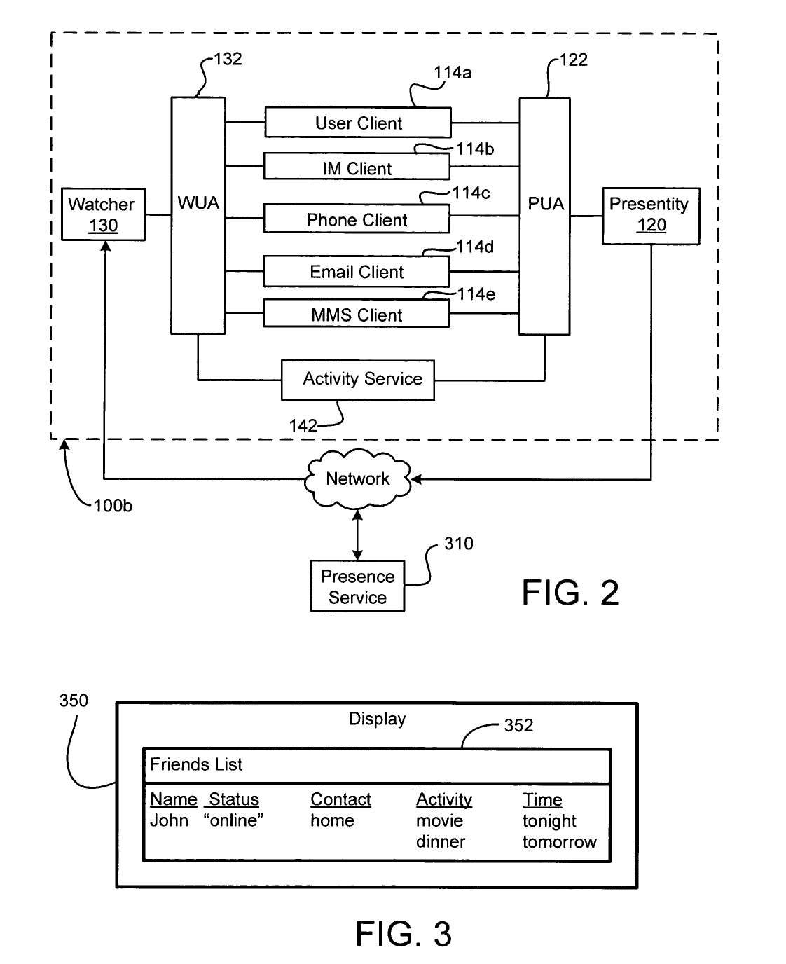

FIG. 2 is a block diagram of an exemplary device, e.g., 100b, according to one embodiment of the present invention. In this example, the client device 100b is a personal computer includes a plurality of presence clients 114a-114e through which a user 112 of the device 100b can be represented to the presence service 310 (FIG. 1). For example, the device 100b can include a user client 114a, an IM/Chat client 114b, a phone client 114c, an email client 114d and an MMS client 114e.

The device 100b includes at least one presentity 120. The presentity 120 sends presence information and service presence information reflecting the status of each presence client 114a-114e, to the presence service 310 via the network 200 (FIG. 1). The presentity 120 can be an independent module (as shown) or it can be a module integrated in each presence client 114a-114e, or a combination of both.

Each presence client 114a-114e has access to a presence user agent (PUA) 122 that serves as an interface between the client 114 and the presentity 120. For example, a user of the device 100b can enter presence information concerning him/herself through the PUA 122 in the user client 114a. In another version, the PUA 122 can be an external service used by or acting on behalf of a client 114. The PUA 122 can be customized for a presence client, or it can be a standardized module that can handle several presence clients.

The device 100b includes at least one watcher 130 that is in communication with the plurality of clients 114a-114e. The watcher(s) 130 receive presence information from the presence service 310. The presence information received typically is associated with other presence clients in other devices 100 and/or users in the network 200, such as contacts on the user's friends list.

The presence information received by the watcher 130 is interpreted by a watcher user agent 132 (WUA), which provides an interface to display the presence information for each client 114a-114e. As with presentities 120 and PUAs 122, watchers 130 and WUAs 132 may be integrated with each client 114a-114e or may be an external service used by or acting on behalf of the clients 114a-114e. The WUA 132, like the PUA 122, can be customized for a client 114a, or it can be a standardized module that can handle several clients 114a-114e.

According to a preferred embodiment of the present invention, the device includes 100b an activity service 142 that is in communication with the WUA 132 and PUA 122. The activity service 142 provides an extension that allows a presence client, e.g., the user client 114a, to designate information pertaining to activities the user 112 is interested in participating in now or in the near or distant future. Such information is referred to as “activity information.”

For example, in addition to providing basic status and contact information, i.e., that the presence client 114a is “open” and at home, the presence client 114a, i.e., the user 112, can also indicate that he or she is interested in seeing a movie and/or having dinner. In one embodiment, the activity service 142 can provide an activity pull-down menu in the PUA 122 that lists several activities from which the user 112 can select a desired activity.

The activity service 142 can also allow the user 112 to specify a date and time for each activity and also allow the user 112 to select to which friend(s) the activity information should be directed. In one embodiment, the user 112 can be presented with a calendar from which the user 112 can select a proposed time and date for the activity. The user 112 can also include the calendar in the activity information in order to facilitate scheduling with the selected friends.

In this manner, the user 112 can easily invite one or several friends to participate in one or more activities. The activity service 142 integrates the activity information with the presence client's 114a presence information, e.g., status and contact information, which is then sent to the presence service 310 via the presentity 120.

The presence service 310 receives the presence information from the presence client 114a, updates the presence tuple associated with the presence client 114a, and sends the presence information to other presence clients 114 associated with the selected friends. Note that the invitation(s) are delivered in real-time to those friends who are logged on.

Similarly, the activity service 142 is capable of interpreting activity information pertaining to other presence clients 114, i.e., friends, that is received by the watcher 130. Such activity information can be displayed to the presence client 114a via the WUA 132.

FIG. 3 is an illustration of an exemplary user interface provided by the WUA 132 according to one embodiment of the present invention. The display 350 includes a friends list 352 associated with the user 112 of the user client 114a. In this version, the friends list 352 provides the name of each contact on the list, the status and contact information of the friend, and activities to which the user 112 is invited to participate. In a preferred embodiment, the user 112 can select an activity he or she is also interested in, e.g., the movie, and automatically send a confirmation message to the inviting party accepting the invitation. Optionally, the user 112 can add a message to the confirmation designating, for example, a particular movie or theater.

In a preferred embodiment, the extension provided by the activity service 142 is compatible with the standard IM platform. For example, in one embodiment, a presence tuple associated with the presence client 114a is extended to include a new status field representing the activity information.

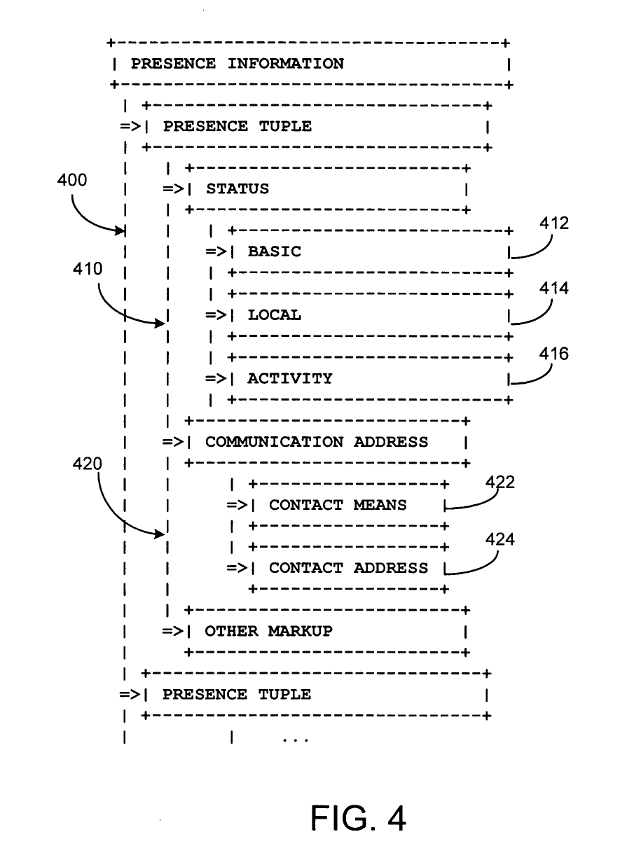

FIG. 4 is an exemplary presence tuple according to one embodiment of the present invention. As is shown, the presence tuple 400 is a structured document that includes a plurality of fields or elements. The presence tuple 400 typically includes a status element 410, which indicates the presence client's status information, and a communication address element 420, which indicates the presence client's contact information. The status element 410 typically includes a basic status subelement 412, which indicates the presence client's basic status, e.g., “open,” “closed,” etc., and a local status subelement 414, which indicates the presence client's location, e.g., “home.”

According to a preferred version of the present invention, the status element 410 is extended to include an activity subelement 416, which indicates one or more activities the presence client 114 is interested in participating in now and/or in the future. In one embodiment, the activity subelement 416 can itself include one or more subelements (not shown) that indicate, for each activity, details related to the activity, e.g., date, time, place, selected friends. For example,

<activity>

<activity details>=“Swamp Thing”>movie</activity details>
<timeframe>2005.04.17-20 Evenings</timeframe>
<location>Twin Cinemas, Bijou</location>
<friends>joe284, rpsmith, juli18</friends>

</activity>

indicates that the presence client 114a is interested in seeing the movie, Swamp Thing, on certain evenings, at a certain movie theater, and with particular friends.

In the above example, the activity subelement 416 is an extension of the status element 410. In another version, the activity subelement 416 can be an extension of the presence tuple 400 itself. Also, other subelements can be defined and used to replace or supplement the activity subelement 416, as would be appreciated by those with ordinary skill in the art. Because the present invention is compatible with the standard IM platform, little or no modification to the presence service 310, PUA 122, presentity 120, WUA 132 and watcher 130 is required.

According to another exemplary embodiment, the tuple (or presence tuple) can include an activity link element corresponding to each activity. Each activity link element can be associated with an activity element included in a database. For example, each activity link element can include a reference to a record location in a database that includes the activity element. In this arrangement, the tuple (or presence tuple) including the activity link element and the record location in the database including the activity element can together be considered a tuple associated with the presence client 114a.

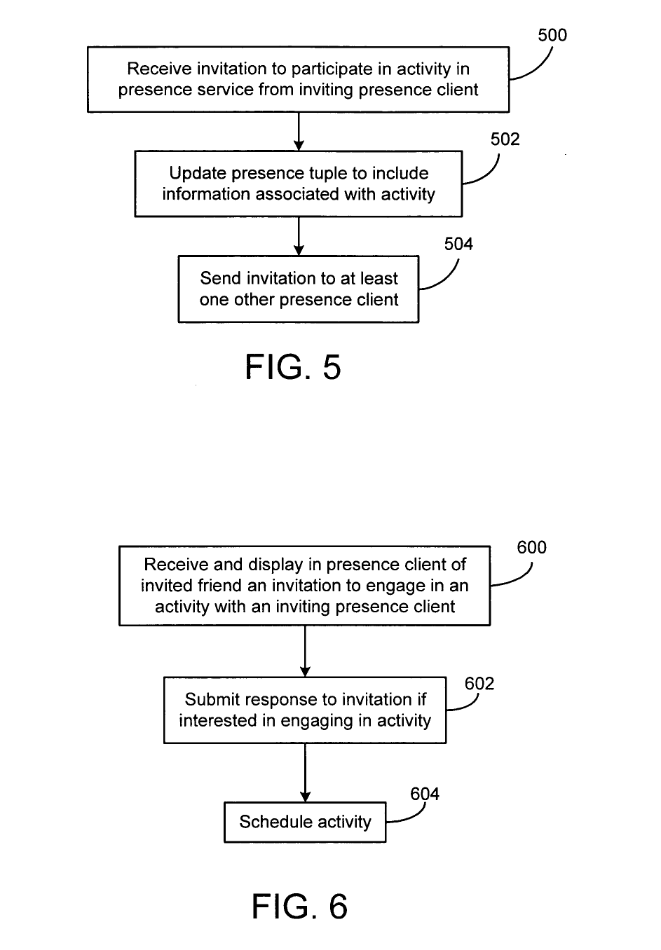

FIG. 5 is a high-level flowchart of a method for advertising an invitation to engage in an activity according to one embodiment of the present invention. Referring to FIG. 1 and FIG. 5, the process begins when the presence service 310 receives the invitation from an inviting presence client 114 in a device, e.g., the computer 100b (step 500). In a preferred embodiment, the invitation comprises activity information. As stated above, the activity information is preferably integrated with the presence information associated with the inviting presence client 114, and includes information related to the activity the inviting presence client 114 is interested in participating in now and/or in the future. For example, the activity information can include the type of activity, a time, a place and a cost.

After the presence service 310 receives the invitation, the presence service 310 updates the presence tuple 400 (FIG. 4) associated with the presence client 114 to include the information related to the activity (step 502). For example, referring to FIG. 4, the activity element 416 can be updated to specify the activity type. In one embodiment, a timeframe sub-element, a location sub-element, and a friends sub-element can also be updated to specify the proposed time and place for the activity and to who the invitation should be directed, respectively. Referring again to FIG. 5, once the presence tuple 400 is updated, the presence service 310 sends the presence information, which includes the invitation, to other presence clients 114 in other devices, e.g., the camera 100a and the phone 100c, associated with the invited friends (step 504).

FIG. 6 is a flowchart illustrating a process for responding to an invitation to engage in an activity according to a preferred embodiment of the present invention. The process begins when a presence client 114 associated with an invited friend receives and displays the presence information, which includes the invitation to engage in an activity, associated with the inviting presence client 114 (step 600). If the friend is interested in the activity, the friend can submit a response to the invitation (step 602). In one embodiment, the response can be an instant message sent directly to the inviting presence client 114. In another version, the WUA 132 (FIG. 2) can display to the friend one or more automated replies and the friend can select an appropriate automated reply that is then sent to the inviting presence client 114. In another version, the friend can simply respond in any reasonable manner, such as by calling the inviting user directly. While the friend is typically the user of the device 100a, nothing prevents the friend from being the device itself 100a, a component (not shown) in the device 100a, or another service or application running on the device 100a.

Once the friend has submitted the response to the invitation (step 602), the friend and the user 112 of the inviting presence client 100b can schedule the activity (step 604). Scheduling the activity typically involves determining a mutually convenient time and place. This process is simple if both parties are able to communicate directly with one another in real time either through an IM service, phone call, or other suitable manner.

Scheduling, however, becomes complicated if the parties cannot communicate directly in real time because the inviting user is not online, i.e., the inviting presence client 114 has logged off the presence service 310, or the inviting user is on another phone call and cannot talk to the friend, or otherwise unavailable. In this situation, the friend must resort to leaving a message and waiting for a reply. In the meantime, the friend can log off, leave the office or house, or go into a meeting. Typically, the parties can end up playing “message tag” with each other. Moreover, scheduling can become complicated and tedious if the activity requires several parties to agree on a time and place.

In a preferred embodiment, a scheduler service 340 is associated with the presence service 310 (FIG. 1) to facilitate scheduling an activity between two or more presence clients 114. The scheduler service 340 receives calendars associated with each of the presence clients 114 and stores the calendars in the friends data structure 332 along with the other client related information. The scheduler service 340 then uses the calendars of the parties to schedule proposed non-conflicting times for the activity. In this manner, the scheduling process between two or more parties can be simplified and automated.

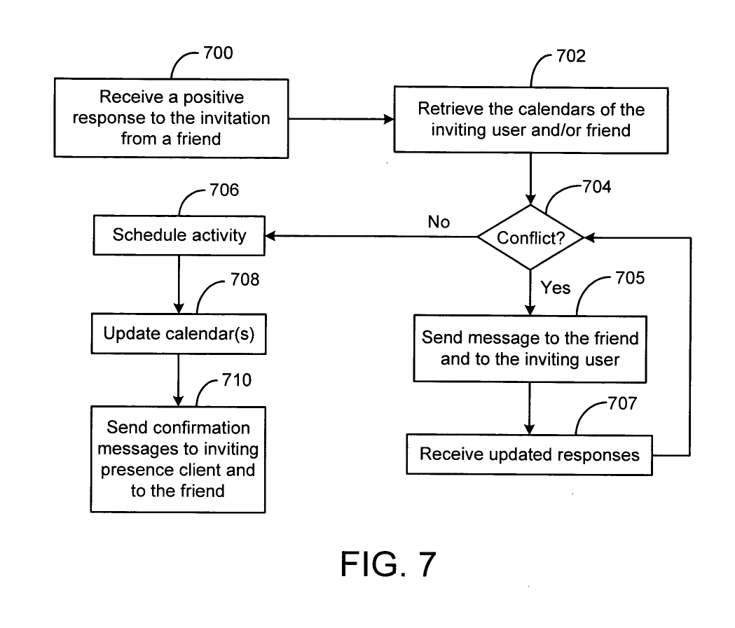

FIG. 7 is a flowchart illustrating a method of automatically scheduling an activity according to one embodiment of the present invention. Referring to FIG. 1 and FIG. 7, the process begins when the presence service 310 receives a positive response to an invitation to engage in an activity from a presence client 114 associated with an invited friend (step 700). In one embodiment, the response can include a proposed day and time for the activity. In another version, the day and time is specified by the invitation. In yet another version, neither the response nor the invitation specifies the day and/or time. In any case, the scheduler service 340 retrieves from the friends data structure 332 the appropriate calendar associated with either the inviting user 112 (referred to as a “host”), the invited friend, or both (step 702).

The scheduler service 340 checks for conflicts in proposed days and/or times (if such are included in the response or in the invitation) and if a conflict exists (step 704), the scheduler service 340 sends messages to the host 112 and to the friend informing them of the conflict (step 705). In one embodiment, the conflict message can include a request to propose a different day and/or time, and in such circumstances, the presence service 310 receives updated responses from the host and/or invited friends (step 707), and steps 702 through 707 are repeated until the conflict is resolved.

If a conflict does not exist (step 704) or a conflict is resolved, the scheduler service 340 schedules the activity (step 706), updates the calendars (step 708) and sends confirmation messages to the host and to the invited friend (step 710). Although the process illustrated in FIG. 7 involves only two parties, it can be applied to a plurality of parties. Accordingly, the scheduler service 340 can automatically facilitate the scheduling of a group of friends to engage in an activity.

According to aspects of the present invention, a presence client can advertise its availability to engage in specified activities to other presence clients on a friends list by utilizing a presence service. The inviting presence client can specify details of the activity in the invitation. Such details can include a timeframe and a place for each activity, as well as which friends on the friends list will receive an invitation. The presence service updates the presence tuple associated with the inviting presence client and sends the invitation to the invited friends. An invited friend can submit a response to the invitation directly or indirectly to the host. In one embodiment, a scheduler service 340 integrated with the presence service 310 automatically coordinates the scheduling process between two or more parties for an activity.

According to aspects of the present invention, a user can invite one or more friends to an activity informally and without the stress associated with a possible rejection of a direct invitation. The invitation can be sent to several friends simultaneously and the scheduling can be automated by the scheduler service. Thus, coordinating an activity is simplified.

The present invention is directed to a method and system for advertising over a network an invitation to engage in at least one activity. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method of advertising over a network an invitation to engage in at least one activity, the method comprising:
receiving by a presence service on the network activity information related to the at least one activity via an inviting presence client;
updating a tuple associated with the inviting presence client to include the information related to the at least one activity; and
sending the invitation to engage in the at least one activity from the presence service to at least one other presence client on the network.

2. A method according to claim 1 further including:
receiving a response to the invitation from the at least one other presence client on the network, wherein the at least one other presence client is a friend on a friends list associated with the inviting presence client thereby enabling the scheduling of the activity.

3. A method according to claim 2, wherein receiving the response includes:
relaying a message over the network from a device associated with the other presence client to a device associated with the inviting presence client.

4. A method according to claim 2, wherein scheduling includes:
providing a scheduler service associated with the presence service to automatically schedule a day or time in which to engage in the at least one activity.

5. A method according to claim 4 wherein scheduling further includes:
retrieving a calendar associated with at least one of the inviting presence client and the friend; and
using the calendar to determine a mutually agreeable day and time for the activity.

6. A method according to claim 1 further comprising:
providing for the at least one activity to be specified in the inviting presence client; and
for each of the at least one activity specified, allowing at least one friend from a friends list to which an invitation will be directed to be selected.

7. A method according to claim 6, wherein the activity information received by the presence service includes the at least one activity and, for each activity, at least one friend associated with the activity, wherein the at least one friend is associated with a presence client registered with the presence service.

8. A method according to claim 1 wherein updating the tuple includes:
modifying an activity element in the tuple corresponding to each activity.

9. A method according to claim 8 wherein modifying the activity element includes:
updating a timeframe sub-element and a location sub-element for each activity element.

10. The method according to claim 1 wherein the tuple includes an activity link element corresponding to each activity, each activity link element being associated with an activity element included in a database, wherein updating the tuple includes:
modifying the activity element in the database corresponding to each activity.

11. The method of according to claim 1, wherein the tuple is a presence tuple.

12. A computer readable medium having computer program instructions for advertising over a network an invitation to engage in at least one activity, the program instructions for:
receiving by a presence service on the network activity information related to the at least one activity via an inviting presence client;
updating a tuple associated with the inviting presence client to include the information related to the at least one activity; and
sending the invitation to engage in the at least one activity from the presence service to at least one other presence client on the network.

13. A computer readable medium according to claim 12 further including program instructions for:
receiving a response to the invitation from the at least one other presence client on the network, wherein the at least one other presence client is a friend on a friends list associated with the inviting presence client thereby enabling the scheduling of the activity.

14. A computer readable medium according to claim 13 wherein receiving the response includes:
relaying a message over the network from a device associated with the other presence client to a device associated with the inviting presence client.

15. A computer readable medium according to claim 13 wherein scheduling includes:
providing a scheduler service associated with the presence service to automatically schedule a day or time in which to engage in the at least one activity.

16. A computer readable medium according to claim 15 wherein scheduling further includes:
retrieving a calendar associated with at least one of the inviting presence client and the friend; and
using the calendar to determine a mutually agreeable day and time for the activity.

17. A computer readable medium according to claim 12 further comprising program instructions for:
specifying in the inviting presence client the at least one activities; and
for each of the at least one activity specified, allowing at least one friend from a friends list to which an invitation will be directed to be selected.

18. A computer readable medium according to claim 17 wherein the activity information received by the presence service includes the at least one activity and, for each activity, at least one friend associated with the activity, wherein the at least one friend is associated with a presence client registered with the presence service.

19. A computer readable medium according to claim 12 wherein updating the tuple includes:
modifying an activity element in the tuple corresponding to each activity.

20. A computer readable medium according to claim 19 wherein modifying the activity element includes:
updating a timeframe sub-element and a location sub-element for each activity element.

21. A computer readable medium according to claim 12 wherein the tuple includes an activity link element corresponding to each activity, each activity link element being associated with an activity element included in a database, wherein updating the tuple includes:
modifying the activity element in the database corresponding to each activity.

22. A computer readable medium according to claim 12 wherein the tuple is a presence tuple.

23. A system for advertising over a network an invitation to engage in at least one activity, the system comprising:
an inviting presence client in a device coupled to the network for creating and sending activity information related to the at least one activity;
a presence service on the network that receives the activity information related to the at least one activity from the inviting presence client, updates a tuple associated with the inviting presence client to include the information related to the at least one activity, and sends the invitation; and
at least one other presence client in another device on the network that receives the invitation to engage in the at least one activity from the presence service.

24. A system according to claim 23 wherein the activity information specifies an activity type, a day, time and place for the activity, and one or more friends from a friends list associated with the inviting presence client and the presence service sends the invitation to the specified one or more friends.

25. A system according to claim 24 further comprising a scheduler service that automatically schedules a day or time in which to engage in the at least one activity, wherein the scheduler retrieves a calendar associated with at least one of the inviting presence client and the friend, and uses the calendar to determine a mutually agreeable day and time for the activity.

26. A method of advertising over a network an invitation to engage in at least one activity, the method comprising:
receiving by a service on the network a publish request comprising activity information related to the at least one activity via an inviting client;
updating a record associated with the inviting client to include the information related to the at least one activity; and
sending a notify command comprising the invitation to engage in the at least one activity from the service to a subscribed client on the network.
